(19) United States
(12) Patent Application Publication
(10) Pub. No.: US 2026/0064678 A1
(43) Pub. Date: Mar. 5, 2026

(54) GENERATING HIGH-PERFORMANCE QUERIES USING OPTIMIZED SUBQUERIES

(71) Applicant: Snowflake Inc., Bozeman, MT (US)

(72) Inventors: Mohammad Afroz Alam, Redmond, WA (US); Jianzhun Du, Kirkland, WA (US); Yijun Xie, Kirkland, WA (US)

(21) Appl. No.: 18/816,030

(22) Filed: Aug. 27, 2024

(51) Int. Cl. G06F 16/2453

(52) U.S. Cl. CPC G06F 16/24535

(57) ABSTRACT

A client system of a computing environment including a data platform is provided that optimizes a database query. The client system creates a logical plan tree for a Structured Query Language (SQL) query, with the logical plan tree comprising a set of nodes. The client system identifies a set of duplicate nodes in the set of nodes of the logical plan tree and identifies a duplicate subtree in the logical plan tree by determining a set of root nodes of the duplicate subtree using parent-child relationships of the set of nodes. The client system generates an optimized query by replacing instances of subqueries represented by the duplicate subtree using a set of optimized subqueries. The client system communicates the optimized query to the data platform for execution.

### TECHNICAL FIELD

Examples of the disclosure relate generally to data platforms and, more specifically, to optimizing database queries.

### BACKGROUND

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to type of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems. Cloud-based data platforms may communicate data between databases.

### BRIEF DESCRIPTION OF THE DRAWINGS

The present disclosure will be understood more fully from the detailed description given below and from the accompanying drawings of various examples of the disclosure.

FIG. 1 illustrates an example computing environment that includes a network-based data platform in communication with a cloud storage provider user system, according to some examples.

FIG. 2 is a block diagram illustrating components of a compute service manager, according to some examples.

FIG. 3 is a block diagram illustrating components of an execution platform, according to some examples.

FIG. 4 is a collaboration diagram illustrating a DataFrame framework 400, according to some examples.

FIG. 5 illustrates a query optimization method, according to some examples.

FIG. 6 illustrates a query optimization process, according to some examples.

FIG. 7 illustrates a diagrammatic representation of a machine in the form of a computer system within which a set of instructions may be executed for causing the machine to perform any one or more of the methodologies discussed herein, according to some examples.

### DETAILED DESCRIPTION

Data platforms are widely used for data storage and data access in computing and communication contexts. These platforms can have various architectures, including on-premises, network-based (e.g., cloud-based), or a combination of both. They can implement different types of data processing, such as online transactional processing (OLTP), online analytical processing (OLAP), or a combination of these. Data platforms often include relational database management systems (RDBMS) and may communicate data between databases. However, as data volumes grow and queries become more complex, optimizing query performance becomes increasingly challenging. Traditional query execution methods may struggle with repeated subqueries, leading to inefficient processing and increased resource consumption.

A problem in data platforms is the inefficient handling of repeated subqueries in complex SQL statements. When a query contains multiple instances of the same subquery, the database engine may execute that subquery multiple times, unnecessarily duplicating work and consuming additional resources. This can lead to slower query execution times and reduced overall system performance. Another technical problem is the difficulty in optimizing queries that involve large datasets and complex operations, particularly in distributed computing environments. As data platforms scale to handle larger volumes of data and more intricate analytical tasks, there is a growing need for advanced query optimization techniques that can improve performance without requiring extensive manual intervention or expertise in query tuning.

In some examples, using methodologies described in this disclosure, a client system of a data platform creates a logical plan tree for a Structured Query Language (SQL) query, with the logical plan tree comprising a set of nodes. The client system identifies a set of duplicate nodes in the set of nodes of the logical plan tree and identifies a duplicate subtree in the logical plan tree by determining a set of root nodes of the duplicate subtree using parent-child relationships of the set of nodes. The client system then generates an optimized query by replacing instances of subqueries represented by the duplicate subtree using a set of optimized subqueries. The client system communicates the optimized query to a data platform for execution. By replacing the instances of the subquery represented by the duplicate subtree with optimized subqueries, the client system effectively eliminates redundant computations, reducing resource consumption and improving query execution times. This approach is beneficial for complex queries involving large datasets and distributed computing environments, as it automatically optimizes the query structure without requiring manual intervention or extensive query tuning expertise. The execution of the optimized query then leverages these improvements, resulting in more efficient data processing and overall enhanced system performance.

In some examples, the client system determines the set of root nodes of the duplicate subtree by performing specific operations for each duplicate node in the set of duplicate nodes. For each duplicate node, the client system determines if at least one parent node of that duplicate node is not in the set of duplicate nodes. If the client system determines that at least one parent node is not in the set of duplicate nodes, the client system adds the duplicate node to the set of root nodes of the duplicate subtree. This process helps identify the root nodes of instances of the duplicate subtree within the logical plan tree.

In some examples, the client system determines the set of root nodes of the duplicate subtree by performing specific operations for each duplicate node in the set of duplicate nodes. For each duplicate node, the client system determines if the duplicate node has two or more different parent nodes. If the client system determines that the duplicate node has two or more different parent nodes, it adds the duplicate node to the set of root nodes of the duplicate subtree.

In some examples, the set of optimized subqueries includes a first instance of the duplicate subquery including instructions to create a Common Table Expression (CTE) and one or more subsequent references to the CTE.

In some examples, the set of optimized subqueries includes a first instance of a duplicate subquery and one or more subsequent references to a stored result of the first instance of the duplicate subquery.

Reference will now be made in detail to specific examples for carrying out the inventive subject matter. Examples of these specific examples are illustrated in the accompanying drawings, and specific details are set forth in the following description in order to provide a thorough understanding of the subject matter. It will be understood that these examples are not intended to limit the scope of the claims to the illustrated examples. On the contrary, they are intended to cover such alternatives, modifications, and equivalents as may be included within the scope of the disclosure.

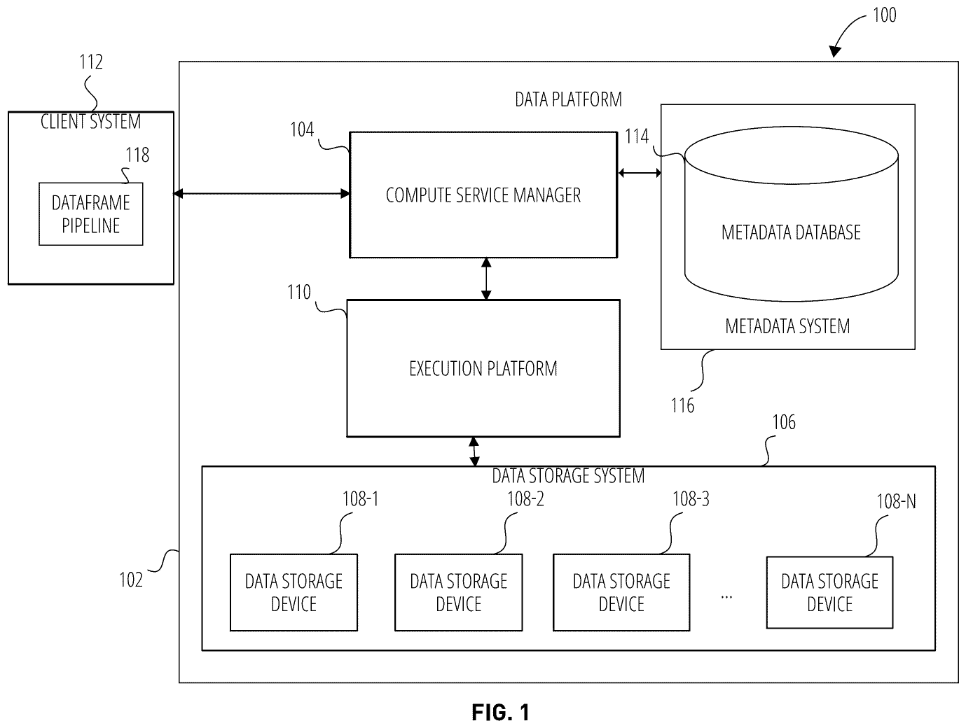

FIG. 1 illustrates an example computing environment 100 that includes a data platform 102 in communication with a client system 112, according to some examples. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the data platform 102 comprises a data storage system 106, a compute service manager 104, an execution platform 110, and a metadata system 116. The data storage system 106 comprises a plurality of computing machines and provides on-demand computer system resources such as data storage and computing power to the data platform 102. As shown, the data storage system 106 comprises multiple data storage devices, such as data storage device 108-1, data storage device 108-2, data storage device 108-3, and data storage device 108-N. In some examples, the data storage devices 1 to N are cloud-based storage devices located in one or more geographic locations. For example, the data storage devices 1 to N may be part of a public cloud infrastructure or a private cloud infrastructure. The data storage devices 1 to N may be hard disk drives (HDDs), solid state drives (SSDs), storage clusters, Amazon S3™ storage systems or any other data storage technology. Additionally, the data storage system 106 may include distributed file systems (e.g., Hadoop Distributed File Systems (HDFS)), object storage systems, and the like.

In some examples, one or more of the data storage devices 108-1 to 108-N are cloud-based datastores configured as Virtual Private Clouds (VPCs). In some examples, A VPC is a secure, isolated virtual network within a public cloud environment that allows organizations to run and manage their cloud resources with enhanced control and privacy. A VPC can provide the functionality of a traditional data center without the physical management and maintenance overhead, enabling users to define their own network space. This includes selecting IP address ranges, creating subnets, configuring route tables, and setting up network gateways. VPCs are beneficial for entities that desire a partitioned section of the cloud to ensure that their applications and data are isolated from other users on the same public cloud platform. This isolation helps in maintaining security and compliance with regulatory requirements, while also allowing for scalable and flexible resource management.

In some examples, data objects are stored in structured data files. The structured data files can be in various structured file formats such as, but not limited to, Comma-Separated Values (CSV) JavaScript Object Notation (JSON), Apache Avro (Avro), Apache Parquet (Parquet) Optimized Row Columnar (ORC), Extensible Markup Language (XML), and the like.

In some examples, the data platform 102 organizes data storage using micro-partitions of a database table using a suitable structured data file format specifically designed for optimal performance and security within the computing environment 100 such as, but not limited to, Flocon De Neige (FDN) and the like. Whenever new data is added to a table, new micro-partition files are created. This approach ensures that data is stored in an immutable format where the addition of a new record results in the generation of a new micro-partition file.

The data platform 102 is used for reporting and analysis of integrated data from one or more disparate sources including the storage devices 1 to N within the data storage system 106. The data platform 102 hosts and provides data reporting and analysis services to multiple consumer accounts. Administrative users can create and manage identities (e.g., users, roles, and groups) and use privileges to allow or deny access to identities to resources and services. Generally, the data platform 102 maintains numerous consumer accounts for numerous respective consumers. The data platform 102 maintains each consumer account in one or more storage devices of the data storage system 106. Moreover, the data platform 102 may maintain metadata associated with the consumer accounts in the metadata database 114 of the metadata system 116. Each consumer account includes multiple objects with examples including users, roles, privileges, a datastores or other data locations.

The compute service manager 104 coordinates and manages operations of the data platform 102. The compute service manager 104 also performs query optimization and compilation as well as managing clusters of compute services that provide compute resources (also referred to as “virtual warehouses”). The compute service manager 104 can support any number and type of clients such as end users providing data storage and retrieval requests, system administrators managing the systems and methods described herein, and other components/devices that interact with compute service manager 104. As an example, the compute service manager 104 is in communication with the client system 112. The client system 112 can be used by a user of one of the multiple consumer accounts supported by the data platform 102 to interact with and utilize the functionality of the data platform 102.

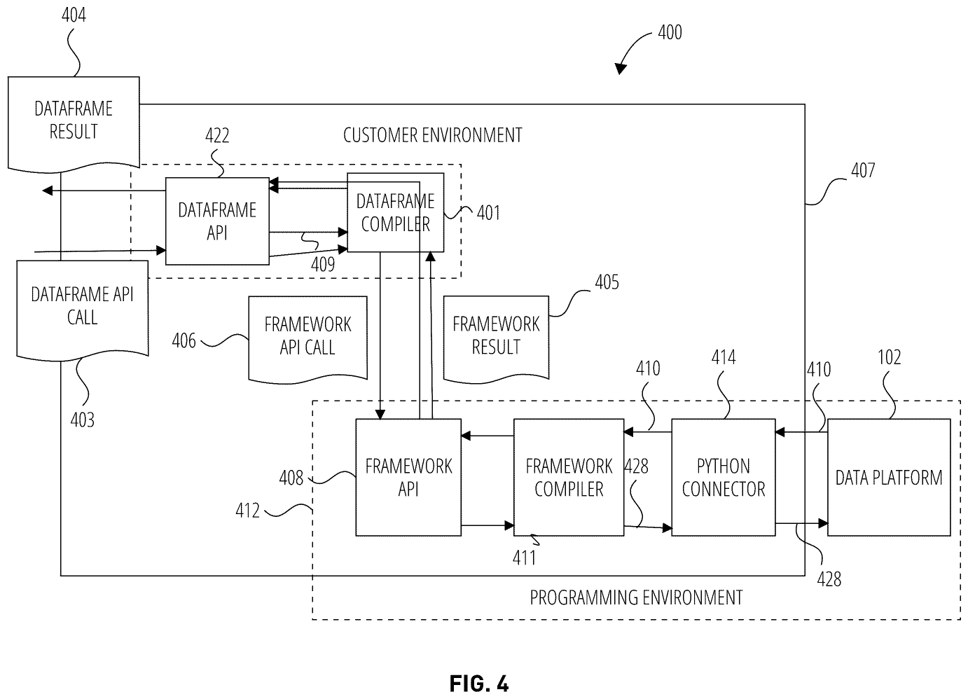

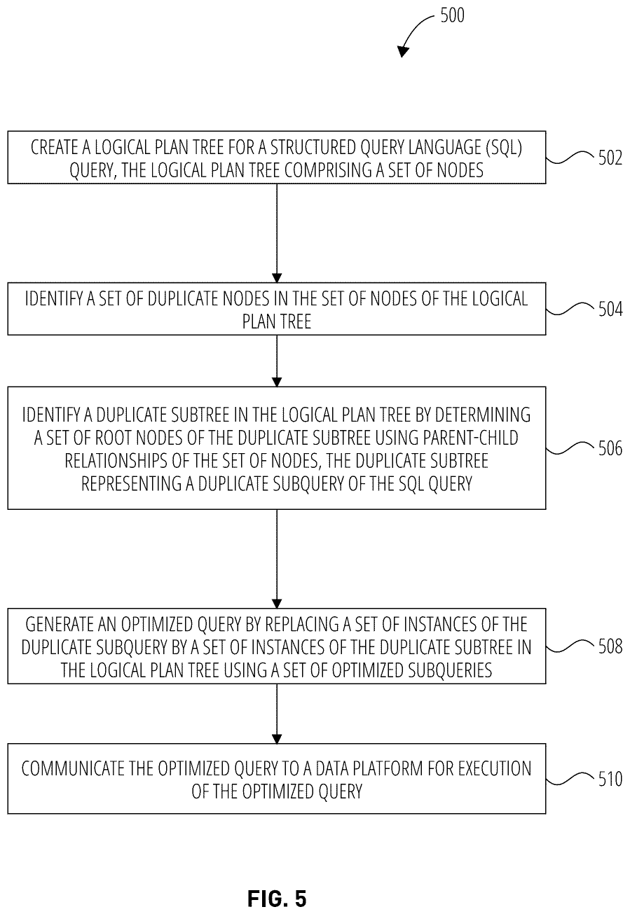

In some examples, the client system 112 includes a DataFrame pipeline 118 that provides an end-to-end sequence for manipulating DataFrame data structures within a programming and run-time environment of the client system 112. The DataFrame pipeline 118 allows users to write data pipelines quickly and effectively for various scenarios, ranging from interactive analytics to complex batch workloads, directly against data in the data platform 102 at scale. The operations of the DataFrame pipeline 118 are more fully described in reference to FIG. 4 and FIG. 5.

In some examples, the compute service manager 104 does not receive any direct communications from the client system 112 and only receives communications concerning jobs from a queue within the data platform 102.

The compute service manager 104 is also coupled to metadata database metadata system 116. The metadata system 116 includes a metadata database 114 that stores metadata pertaining to various functions and examples associated with the data platform 102 and its users. In some examples, the metadata database 114 includes a summary of data stored in remote data storage systems as well as data available from a local cache. In some examples, the metadata database 114 may include information regarding how data is organized in remote data storage systems (e.g., the data storage system 106) and the local caches. In some examples, the metadata database 114 include data of metrics describing usage and access by provider users and consumers of the data stored on the data platform 102. In some examples, the metadata database 114 allows systems and services to determine whether a piece of data needs to be accessed without loading or accessing the actual data from a storage device.

The compute service manager 104 is further coupled to the execution platform 110, which provides multiple computing resources that execute various data storage and data retrieval tasks. The execution platform 110 is coupled to the data storage system 106. The execution platform 110 comprises a plurality of compute nodes. A set of processes on a compute node executes a query plan compiled by the compute service manager 104. The set of processes can include: a first process to execute the query plan; a second process to monitor and delete micro-partition files using a least recently used (LRU) policy and implement an out of memory (OOM) error mitigation process; a third process that extracts health information from process logs and status to send back to the compute service manager 104; a fourth process to establish communication with the compute service manager 104 after a system boot; and a fifth process to handle communication with a compute cluster for a given job provided by the compute service manager 104 and to communicate information back to the compute service manager 104 and other compute nodes of the execution platform 110.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another. In alternate examples, these communication links are implemented using any type of communication medium and any communication protocol.

As shown in FIG. 1, the data storage devices data storage device 108-1 to data storage device 108-N are decoupled from the computing resources associated with the execution platform 110. This architecture supports dynamic changes to the data platform 102 based on the changing data storage/retrieval needs as well as the changing needs of the users and systems. The support of dynamic changes allows the data platform 102 to scale quickly in response to changing demands on the systems and components within the data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

The compute service manager 104, metadata system 116, execution platform 110, and data storage system 106 are shown in FIG. 1 as individual discrete components. However, each of the compute service manager 104, metadata system 116, execution platform 110, and data storage system 106 may be implemented as a distributed system (e.g., distributed across multiple systems/platforms at multiple geographic locations). Additionally, each of the compute service manager 104, metadata system 116, execution platform 110, and data storage system 106 can be scaled up or down (independently of one another) depending on changes to the requests received and the changing needs of the data platform 102. Thus, in the described examples, the data platform 102 is dynamic and supports regular changes to meet the current data processing needs.

During operation, the data platform 102 processes multiple jobs determined by the compute service manager 104. These jobs are scheduled and managed by the compute service manager 104 to determine when and how to execute the job. For example, the compute service manager 104 may divide the job into multiple discrete tasks and may determine what data is needed to execute each of the multiple discrete tasks. The compute service manager 104 may assign each of the multiple discrete tasks to one or more nodes of the execution platform 110 to process the task. The compute service manager 104 may determine what data is needed to process a task and further determine which nodes within the execution platform 110 are best suited to process the task. Some nodes may have already cached the data needed to process the task and, therefore, be a good candidate for processing the task. Metadata stored in the metadata database 114 assists the compute service manager 104 in determining which nodes in the execution platform 110 have already cached at least a portion of the data needed to process the task. One or more nodes in the execution platform 110 process the task using data cached by the nodes and, if necessary, data retrieved from the data storage system 106. It is desirable to retrieve as much data as possible from caches within the execution platform 110 because the retrieval speed is typically faster than retrieving data from the data storage system 106.

As shown in FIG. 1, the computing environment 100 separates the execution platform 110 from the data storage system 106. In this arrangement, the processing resources and cache resources in the execution platform 110 operate independently of the database storage devices data storage device 108-1 to data storage device 108-N in the data storage system 106. Thus, the computing resources and cache resources are not restricted to a specific one of the data storage device 108-1 to data storage device 108-N. Instead, computing resources and cache resources may retrieve data from, and store data to, any of the data storage resources in the data storage system 106.

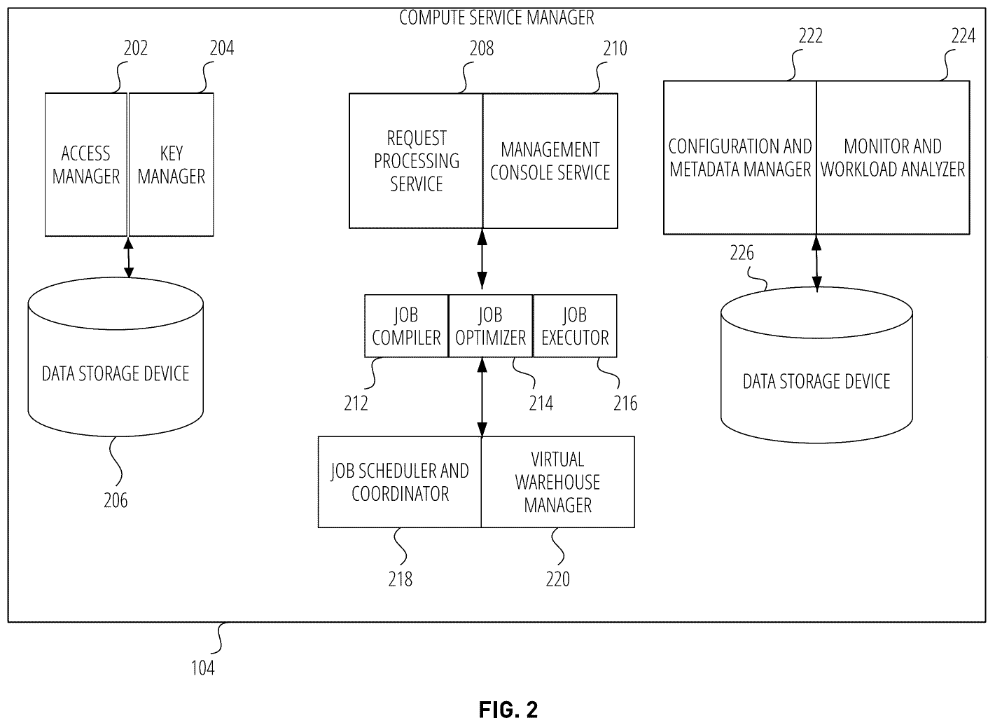

FIG. 2 is a block diagram illustrating components of the compute service manager 104, according to some examples. As shown in FIG. 2, the compute service manager 104 includes an access manager 202, and a key manager 204. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage data storage device 206). As used herein, the remote storage devices may also be referred to as “persistent storage devices” or “shared storage devices.”

In some examples, the access manager 202 operates within a data platform to control access to various objects of the data platform using Role-Based Access Control (RBAC). The access manager 202 is a component that manages authentication and authorization tasks, providing for authorized entities to access specific resources within the data platform. This component plays a role in maintaining the security and integrity of the data platform by enforcing access policies defined through RBAC.

In some examples, RBAC is implemented by defining roles within the data platform, where each role is associated with a specific set of permissions. These permissions determine the actions that entities assigned to the role can perform on various objects within the data platform. The access manager 202 utilizes these roles to make access control decisions, allowing or denying requests based on the roles assigned to the requesting entity and the permissions associated with those roles.

In some examples, the data platform creates specific access roles based on a manifest of an application received from an application package. These access roles are activated by the access manager 202 and are used to govern access to objects used by the application during operation. For example, an access role may grant the application the ability to create a compute pool and execute a service within that compute pool. The access manager 202 provides that an application, or entities authorized by the application, can perform actions permitted by the access role.

In some examples, the access manager 202 also controls access to objects of the data platform using the access roles during the execution of the service within the compute pool. The service accesses objects of the application package and of the data platform under the governance of the activated access roles. The access manager 202 checks the permissions associated with the access roles against the access requests made by the service, granting or denying these requests based on the defined RBAC policies.

In some examples, the role of the access manager 202 extends to managing access to hidden repositories within a provider account, where the application package is stored. The access manager 202 uses RBAC to restrict access to a hidden repository, providing for the application package to be accessible to entities with the appropriate access role. This mechanism protects the application package from unauthorized access, preserving the integrity of the provider's intellectual property.

In some examples, the access manager 202 implements RBAC to isolate the compute pool, preventing the service from accessing other services or resources not specified in the application package. This isolation is achieved by defining access roles that explicitly limit the service's permissions to the resources provided for the operation of the service, thereby enhancing the security of the service execution environment.

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage system 106.

A management console service 210 supports access to various systems and processes by administrators and other system managers. Additionally, the management console service 210 may receive a request to execute a job and monitor the workload on the system.

The compute service manager 104 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 104.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 determines a priority for internal jobs that are scheduled by the compute service manager 104 with other “outside” jobs such as user queries that may be scheduled by other systems in the database but may utilize the same processing resources in the execution platform 110. In some examples, the job scheduler and coordinator 218 identifies or assigns particular nodes in the execution platform 110 to process particular tasks. A virtual warehouse manager 220 manages the operation of multiple virtual warehouses implemented in the execution platform 110. As discussed below, each virtual warehouse includes multiple execution nodes that each include a cache and a processor.

Additionally, the compute service manager 104 includes a configuration and metadata manager 222, which manages the information related to the data stored in the remote data storage devices and in the local caches (e.g., the caches in execution platform 110). The configuration and metadata manager 222 uses the metadata to determine which data micro-partitions need to be accessed to retrieve data for processing a particular task or job. A monitor and workload analyzer 224 oversees processes performed by the compute service manager 104 and manages the distribution of tasks (e.g., workload) across the virtual warehouses and execution nodes in the execution platform 110. The monitor and workload analyzer 224 also redistributes tasks, as needed, based on changing workloads throughout the data platform 102 and may further redistribute tasks based on a user (e.g., “external”) query workload that may also be processed by the execution platform 110. The configuration and metadata manager 222 and the monitor and workload analyzer 224 are coupled to a data storage device 226. Data storage device 226 in FIG. 2 represents any data storage device within the data platform 102. For example, data storage device 226 may represent caches in execution platform 110, storage devices in data storage system 106, or any other storage device.

The compute service manager 104 validates communication from an execution platform (e.g., the execution platform 110) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 304a) may need to communicate with another execution node (e.g., execution node 304b), and should be disallowed from communicating with a third execution node (e.g., execution node 316a) and any such illicit communication can be recorded (e.g., in a log or other location). Also, the information stored on a given execution node is restricted to data relevant to the current query and any other data is unusable, rendered so by destruction or encryption where the key is unavailable.

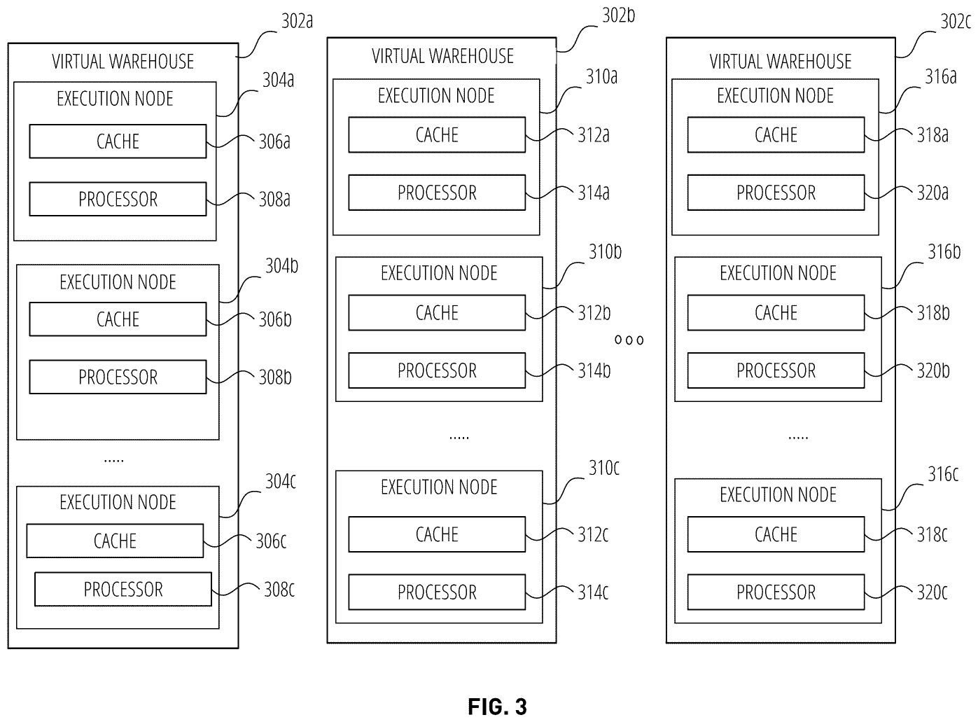

FIG. 3 is a block diagram illustrating components of the execution platform 110, according to some examples. As shown in FIG. 3, the execution platform 110 includes multiple virtual warehouses, including virtual warehouse 302a, and virtual warehouse 302b to virtual warehouse 302c. Each virtual warehouse includes multiple execution nodes that each includes a data cache and a processor. The virtual warehouses can execute multiple tasks in parallel by using the multiple execution nodes. As discussed herein, the execution platform 110 can add new virtual warehouses and drop existing virtual warehouses in real time based on the current processing needs of the systems and users. This flexibility allows the execution platform 110 to quickly deploy large amounts of computing resources when needed without being forced to continue paying for those computing resources when they are no longer needed. Virtual warehouses can access data from any data storage device (e.g., any storage device in data storage system 106).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 1 to N shown in FIG. 1. Thus, the virtual warehouses are not necessarily assigned to a specific data storage device 1 to N and, instead, can access data from any of the data storage devices 1 to N within the data storage system 106. Similarly, each of the execution nodes shown in FIG. 3 can access data from any of the data storage devices 1 to N. In some examples, a particular virtual warehouse or a particular execution node may be temporarily assigned to a specific data storage device, but the virtual warehouse or execution node may later access data from any other data storage device.

In the example of FIG. 3, virtual warehouse 302a includes a plurality of execution nodes as exemplified by execution node 304a, execution node 304b, and execution node 304c. Execution node 304a includes cache 306a and a processor 308a. Execution node 304b includes cache 306b and processor 308b. Execution node 304c includes cache 306c and processor 308c. Each execution node 1 to N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 302a discussed above, virtual warehouse 302b includes a plurality of execution nodes as exemplified by execution node 310a, execution node 310b, and execution node 310c. Execution node 304a includes cache 312a and processor 314a. Execution node 310b includes cache 312b and processor 314b. Execution node 310c includes cache 312c and processor 314c. Additionally, virtual warehouse 302c includes a plurality of execution nodes as exemplified by execution node 316a, execution node 316b, and execution node 316c. Execution node 316a includes cache 318a and processor 320a. Execution node 316b includes cache 318b and processor 320b. Execution node 316c includes cache 318c and processor 320c.

In some examples, the execution nodes shown in FIG. 3 are stateless with respect to the data the execution nodes are caching. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternate examples may include execution nodes containing any number of processors and any number of caches. Additionally, the caches may vary in size among the different execution nodes. The caches shown in FIG. 3 store, in the local execution node, data that was retrieved from one or more data storage devices in data storage system 106. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some examples, the caches are implemented using high-speed memory devices that provide fast access to the cached data. Each cache can store data from any of the storage devices in the data storage system 106.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some examples, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, the virtual warehouses may be implemented using multiple computing systems at multiple geographic locations. For example, virtual warehouse 1 can be implemented by a computing system at a first geographic location, while virtual warehouses 2 and N are implemented by another computing system at a second geographic location. In some examples, these different computing systems are cloud-based computing systems maintained by one or more different entities.

Additionally, each virtual warehouse as shown in FIG. 3 has multiple execution nodes. The multiple execution nodes associated with each virtual warehouse may be implemented using multiple computing systems at multiple geographic locations. For example, an instance of virtual warehouse 302a implements execution node 304a and execution node 304b on one computing platform at a geographic location and implements execution node 304c at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some examples, the virtual warehouses may operate on the same data in data storage system 106, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

FIG. 4 is a collaboration diagram illustrating a DataFrame framework 400 of a client system 112 (of FIG. 1), according to some examples. The DataFrame framework 400 includes a DataFrame API 422 to allow users of the client system 112 to write data pipelines quickly and effectively for a diverse set of scenarios ranging from interactive analytics to complex batch workloads directly against data in the data platform 102 at scale. The DataFrame API 422 performs any operations remotely on the client system 112, where the DataFrame API 422 builds upon the developer framework and programming environment DataFrames. In some examples, the DataFrame API 422 provides an additional, higher-level API employing higher-level API employing PySpark and PANDAS compatible semantics (e.g., style) in the customer environment 407.

The DataFrame framework 400 provides components for creating end-to-end sequences for manipulating DataFrame data structures within the programming environment 412. The DataFrame framework 400 employs consistent semantics (e.g., results behave as if loaded into memory and are not affected by underlying data changes) and deterministic row ordering (e.g., the same queries produce the same results in the same order). The DataFrame framework 400 provides for operations with a customer (e.g., user) making a DataFrame API call 403 through the DataFrame API 422 to invoke an operation or function on a DataFrame.

In some examples, the DataFrame API 422 provides an interface to allow users to manipulate DataFrame data structures using components of the DataFrame framework 400, such as translating operations and functions invoked on DataFrames into equivalent SQL queries. The DataFrame API 422 can further allow a user to leverage familiar DataFrame semantics from libraries such as, but not limited to PANDAS and PySpark, enable performing common data manipulation operations like filtering, aggregations, joins, and the like on large dataset scales, handle pushing operations down into the distributed query execution engine, manage consistency semantics around data snapshots so operations use a consistent view, generate deterministic row ordering based on underlying data layout, facilitate building data pipelines and analysis workflows, and the like.

In some examples, the DataFrame API 422 includes a programmatic interface enabling developers to work with tabular, relational data structures directly at scale within the programming environment 412, rather than needing to extract data or use external engines. The DataFrame API 422 bridges the gap between standard DataFrame manipulations and a distributed SQL query engine.

The DataFrame API 422, or other client-side code, handles (e.g., transmits) the API request 409 to a DataFrame compiler 401. The DataFrame compiler 401 analyzes and parses DataFrame API calls made by a user to translate the DataFrame API call 403 into equivalent SQL queries and operations into a distributed query execution engine. In some examples, the DataFrame compiler 401 manages deterministic row ordering in the generated SQL based on, for example, underlying data layout, as well as handling consistency semantics around data snapshots and optimizing the SQL queries for efficient processing. The DataFrame compiler 401 acts as a logic layer between the user facing DataFrame API 422 and the programming environment 412.

The DataFrame workflow continues by making a framework API call 406 to the framework API 408, using the framework compiler 411 to translate the API calls to optimized SQL queries 428 communicated to the data platform 102. The optimized SQL queries 428 are executed on the data platform 102, and query results 410 are provided back through the programming environment 412 as a framework result 405, which is translated at the DataFrame compiler 401 and/or the DataFrame API 422 into a DataFrame result 404 for presentation to the user.

In some examples, the framework compiler 411 optimizes a SQL query as more fully described in reference to FIG. 5.

After the framework compiler 411 optimizes an SQL query, the optimized query is sent to the Python connector 414, which is then forwarded to the data platform 102 for execution. The Python connector 414 facilitates communication between Python applications and the data platform 102. The Python connector serves as an interface between Python code of the DataFrame workflow and the data platform 102. The Python connector 414 handles tasks such as, but not limited to, establishing and managing connections to the data platform 102. Sending SQL queries generated by the DataFrame workflow to the data platform 102 for execution, receiving and processing results returned from the data platform 102, handling authentication and security protocols for secure communications, and the like.

In some examples, the user (e.g., developer) can query, process, and/or transform data in a variety of ways using the developer framework and programming environment. For example, the user can convert custom lambdas (e.g., small anonymous functions) and functions to user-defined functions (UDFs) that can be called to process data, write a user-defined tabular function (UDTF) that processes data and returns data in a set of rows with one or more columns, write a stored procedure to be called to process data or automate with a task to build a data pipeline, query, and process data with a DataFrame object, or the like. The developer framework and programming environment client environment (e.g., client) brings DataFrame-style programming to multiple programming languages in order to simplify developer building of complex data pipelines and allows developers to interact with the data platform directly without moving data.

In some examples, the DataFrame API of the DataFrame framework 400 translates DataFrame operations to SQL queries, which allow users to combine easily customized SQL code with convenient Python abstractions. Some DataFrame operations require new SQL primitives in the data platform, including SQL primitives based on their priorities.

Additional examples of the DataFrame workflow can include importing a developer framework and programming environment DataFrame module, creating a DataFrame, performing operations on the DataFrame, saving the data to a data platform table, and the like. Examples of the present disclosure enable native DataFrame capabilities at scale in a data platform with correct semantics (e.g., PySpark and PANDAS compatible semantics) and optimized performance. By enhancing the data platform to include a transpiler, such as a Python-to-SQL transpiler, that allows users to use familiar semantics, such as Python DataFrame Library PANDAS, directly integrated with the data platform. Examples include translating DataFrame APIs to equivalent or similar SQL statements to efficiently emulate DataFrame execution, users (e.g., data teams) can leverage Python analytics on terabyte-size and petabyte-size datasets.

FIG. 5 illustrates an example query optimization method 500, according to some examples. The query optimization method 500 provides optimization of queries during processing of queries by a data processing pipeline incorporating components of a DataFrame framework 400 (of FIG. 4) of a client system 112 (of FIG. 1). The client system 112 uses the components of the DataFrame framework 400 to process an SQL query including generating an optimized query from the SQL query. Although the example query optimization method 500 depicts a particular sequence of operations, the sequence may be altered without departing from the scope of the present disclosure. For example, some of the operations depicted may be performed in parallel or in a different sequence that does not materially affect the function of the query optimization method 500. In other examples, different components of an example device or system that implements the query optimization method 500 may perform functions at substantially the same time or in a specific sequence. Although the example query optimization method 500 depicts a particular sequence of operations, the sequence may be altered without departing from the scope of the present disclosure. For example, some of the operations depicted may be performed in parallel or in a different sequence that does not materially affect the function of the query optimization method 500. In other examples, different components of a DataFrame pipeline that implements the query optimization method 500 may perform functions at substantially the same time or in a specific sequence.

In operation 502, a framework compiler 411 (of FIG. 4) creates a logical plan tree for a Structured Query Language (SQL) query where the SQL query is translated into a sequence of logical operations that describe how the data should be processed. For example, a logical plan is structured as a tree including a set of nodes, where each node represents a logical operation, such as selection, projection, join, aggregation, or the like. The tree includes a root node representing the final operation, and the leaves represent the data sources (tables or subqueries). Logical operators describe an intrinsic functionality of the SQL query. They include operations such as, but not limited to, filtering (selection), defining columns to return (projection), and combining tables (joins). The framework compiler 411 parses the SQL query to check for syntax correctness, converts the SQL into an internal representation, such as an Abstract Syntax Tree (AST) or the like comprised of a set of nodes. During a semantic analysis phase, the framework compiler 411 examines the internal representation of the SQL query to verify that all table and column names exist and are valid, resulting in an initial unresolved tree. Following this, name resolution occurs, where table and column names in the unresolved tree are matched to actual database objects. This process creates a resolved tree. The framework compiler 411 transforms the resolved tree into a logical plan tree includes a set of nodes that represent logical operators that represent the high-level operations required to execute the SQL query.

In some examples, a DataFrame operation of the SQL query can create a new parent-child relationship within the logical plan tree by introducing additional nodes and connections in the tree structure. This occurs when operations like filtering, joining, or aggregating are applied to a DataFrame, resulting in new nodes being added to represent these operations and their relationships to existing nodes. The new parent-child relationships reflect the logical dependencies and data flow between different parts of the query. As the query becomes more complex with multiple operations, the logical plan tree grows accordingly, potentially leading to repeated subtrees that represent duplicate computations. This creation of new parent-child relationships is an aspect of how the logical plan tree evolves and forms the basis for identifying opportunities to optimize the query by eliminating repeated subqueries.

In operation 504, the framework compiler 411 identifies a set of duplicate nodes in the set of nodes of the logical plan tree. For example, the framework compiler 411 assigns an identifier to each node in the set of nodes of the logical plan tree and identifies duplicate nodes by matching their identifiers. In some examples, the identifiers are created by parsing a subquery of the node to generate a short but unique name that is used as an identifier for the node.

In operation 506, the framework compiler 411 identifies a duplicate subtree in the logical plan tree by determining a set of root nodes of the duplicate subtree using parent-child relationships of the set of nodes, the duplicate subtree representing a duplicate subquery of the SQL query

For example, the framework compiler 411 determines a set of root nodes of the duplicate subtree by searching through the set of duplicate nodes and, for each duplicate node, determines if at least one parent node of the each duplicate node is not in the set of duplicate nodes. In response to determining that at least one parent node is unique in the logical plan tree (i.e., is not in the set of duplicate nodes), the framework compiler 411 adds the duplicate node to a set of root nodes of the duplicate subtree.

In some examples, the framework compiler 411 determines the set of root nodes of duplicate subtree by searching through the set of duplicate nodes and, for each duplicate node, determines if the duplicate node has two or more different parent nodes. In response to determining the duplicate node has two or more different parent nodes, the framework compiler 411 adds the duplicate node to the set of root nodes of the duplicate subtree.

In operation 508, the framework compiler 411 generates an optimized query by replacing a set of instances of the duplicate subquery represented by a set of instances of the duplicate subtree in the logical plan tree using a set of optimized subqueries. For example, the framework compiler 411 searches a query string of each duplicate node of the set of duplicate nodes iteratively in post order to identify a set of instances of the duplicate subquery referenced by the duplicate subtree. Once the set of instances of the duplicate subtree are identified, the framework compiler 411 can replace the set of instances of the duplicate subquery with a set of optimized queries.

In some examples, the set of optimized subqueries includes a first instance of the duplicate subquery and one or more subsequent references to a stored result of the first instance of the duplicate subquery. For example, the framework compiler 411 replaces the located duplicate subtree with a Common Table Expressions (CTE) of a set of CTEs. CTEs allow definition of a named, temporary result sets within the scope of a single query. A CTE acts as a virtual table that exists for a duration of a query execution, providing a way to break down complex queries into more manageable and readable parts. In some examples, CTEs are initiated using the WITH clause, followed by a name for the expression and the query that defines the result set. Once defined, a CTE can be referenced multiple times within the main query, similar to a regular table. This reusability makes CTEs particularly useful for simplifying complex queries, improving readability, and avoiding repetition of subqueries. CTEs can be used in SELECT, INSERT, UPDATE, DELETE, and MERGE statements, offering flexibility in various query scenarios. They are especially valuable when working with hierarchical or recursive data structures, as they support recursive queries. By organizing SQL statements into logical sections, CTEs enhance query maintainability and reduce the risk of coding errors.

In an example, use of CTEs is illustrated by the following code fragments:
The leaf node is ‘SELECT 1 as a, 2 as b’ in the following query
(SELECT a, b FROM (SELECT 1 as a, 2 as b) WHERE a=1) UNION ALL (SELECT a, b FROM (SELECT 1 as a, 2 as b) WHERE a=1)
search ‘SELECT 1 as a, 2 as b’ and replace it with T1 in the query directly
WITH T1 AS (SELECT 1 as a, 2 as b)
(SELECT a, b FROM (SELECT * FROM T1) WHERE a=1) UNION ALL (SELECT a, b FROM (SELECT * FROM T1) WHERE a=1)
Now ‘SELECT a, b FROM (SELECT 1 as a, 2 as b) WHERE a=1’
becomes ‘SELECT a, b FROM (SELECT * FROM T1) WHERE a=1’
also search this string and replace it with T1 in the query directly
WITH T1 AS (SELECT 1 as a, 2 as b), T2 AS (SELECT a, b FROM (SELECT * FROM T1) WHERE a=1) (SELECT * from T2) UNION ALL (SELECT * from T2)

When optimizing an SQL query, the framework compiler 411 adds instructions to the first instance of a duplicate subquery in the set of optimized subqueries to be executed. The instructions include creating a CTE as a result of the first instance of the duplicate subquery. The CTE is used as a reference by subsequent instances of the duplicate subquery. The framework compiler 411 replaces subsequent instances of the duplicate subquery in the optimized subquery with instructions referencing the CTE to retrieve the results of the first instance of the duplicate subquery. During execution of the optimized query, the data platform 102 creates the CTE as the first instance of the optimized subquery. When subsequent instances of the duplicate subquery are to be executed, the CTE is referenced instead.

In some examples, the framework compiler 411 generates an additional query including a unique placeholder for each root node of the set of root nodes of the logical plan tree of the SQL query and replaces the placeholder with a CTE of the set of CTEs during an evaluation of the SQL query. The following code fragments provide an example:
original query:
SELECT a, b FROM (SELECT 1 as a, 2 as b) WHERE a=1
placeholder query: SELECT a, b FROM (P1) WHERE a=1
original query: (SELECT a, b FROM (SELECT 1 as a, 2 as b) WHERE a=1) UNION ALL (SELECT a, b FROM (SELECT 1 as a, 2 as b) WHERE a=1)
placeholder query: (P2) UNION ALL (P2)

For example, the framework compiler 411 replaces a duplicate subquery represented by a duplicate subtree with a set of optimized subqueries that iteratively materialize instances of the duplicate subquery into temporary tables. This approach obviates the need to append a WITH clause to the original query. Instead, the repeated instances of the duplicate subquery are replaced with references to the temporary tables such as, but not limited to, the names of the temporary tables when the first instance of the optimized query is executed. For example, the framework compiler 411 adds instructions to the first instance of the duplicate subquery in the set of optimized subqueries to materialize the results of a first instance of the duplicate subquery when the first instance of the duplicate subquery is executed. Subsequent instances of the duplicate subquery in the set of optimized subqueries are replaced with instructions referencing the materialized results of the first instance of the duplicate subquery. During execution of the optimized query, the data platform 102 executes the first instance of the optimized subquery independently of the main optimized query. The results are stored in a temporary table. In some examples, the temporary table is stored in memory if the result set is small enough. For larger results, the temporary table can be created in a more permanent datastore. In some examples, the temporary table can be indexed to speed up subsequent lookups. When subsequent instances of the duplicate subquery are to be executed, references to the materialized results of the first instance of the duplicate subquery are used to recall the materialized results and those materialized results are used instead of executing the duplicate subquery.

In some examples, a set of instances of a duplicate subquery represented by a duplicate subtree is replaced with a set of optimized subqueries that use a stored result of a first instance of a duplicate subquery where the stored result is temporarily stored by the data platform 102 during execution of the optimized query. For example, the data platform 102 can temporarily store the results of subqueries in a datastore of the data platform 102. The results are indexed by a query IDentification (ID) unique to each subquery, After executing a subquery, the data platform 102 stores the results temporarily in a result set cache. An SQL function can access these results using the query ID of the executed subquery. The following SQL code fragments illustrate use of a RESULT_SCAN function that returns the results of a previously executed subquery where ‘<query_id>’ is the query ID of the executed subquery: RESULT_SCAN(‘<query_id>’).

When optimizing an SQL query, the framework compiler 411 adds instructions to the first instance of a duplicate subquery in the set of optimized subqueries to be executed. The instructions further include storing a result of the first instance of the duplicate subquery in a datastore referenced by a query ID of the stored duplicate subquery results. The query ID is used as a reference to the stored results by subsequent instances of the duplicate subquery. The framework compiler 411 replaces subsequent instances of the duplicate subquery in the optimized subquery with instructions referencing the query ID to retrieve the results of the first instance of the duplicate subquery using the query ID. During execution of the optimized query, the data platform 102 executes the first instance of the optimized subquery independently of the main optimized query. The results are stored and a query ID referencing the stored results is generated. When subsequent instances of the duplicate subquery are to be executed, the results of the first instance of the duplicate subquery are recalled using the referenced query ID of the previously executed first instance of the duplicate subquery and those results are used instead of executing the subsequent duplicate subquery.

In some examples, the framework compiler 411 replaces the identified set of duplicate subtrees by identifying an identified duplicate subtree of the set of duplicate subtrees when applying a binary operation during DataFrame creation and replaces a duplicate subquery represented by the duplicate subtree with an optimized subquery. For example, the DataFrame framework 400 (of FIG. 4) proactively generates an optimized query upon DataFrame creation. Upon applying a binary operation such as a union or join, the DataFrame framework 400 searches for duplicate subtrees, converts the subqueries of the duplicate subtrees to optimized subqueries, and subsequently generates a final optimized query based on the maintained tree structure

In some examples, the framework compiler 411 determines a size of a set of root nodes of a duplicate subtree representing a duplicate subquery and, in response to determining the size of the set of root node does not exceed a threshold size value, the framework compiler 411 determines to replace instances of the duplicate subquery represented by the duplicate subtree with a set of optimized queries.

In some examples, the framework compiler 411 determines a depth of nested subtrees in a duplicate subtree representing a duplicate subquery and, in response to determining the depth of nested of subtrees does not exceed a threshold depth value, determines to replace instances of the duplicate subquery with the set of optimized queries.

In operation 510, the optimized query is communicated to the data platform 102 for execution. The data platform 102 receives the optimized query and executes the optimized query. For example, the framework compiler 411 communicates an optimized SQL query 428 (of FIG. 4) to a Python connector 414 (of FIG. 4). The Python connector 414 receives the optimized SQL query 428 and communicates the optimized SQL query 428 to the data platform 102. The data platform 102 receives the optimized SQL query 428 and executes the optimized SQL query 428 to generate query results 410 (of FIG. 4) as more fully described in reference to FIG. 1, FIG. 2, and FIG. 3. The data platform 102 communicates the query results back to the Python connector 414 for further processing as more fully described in reference to FIG. 4.

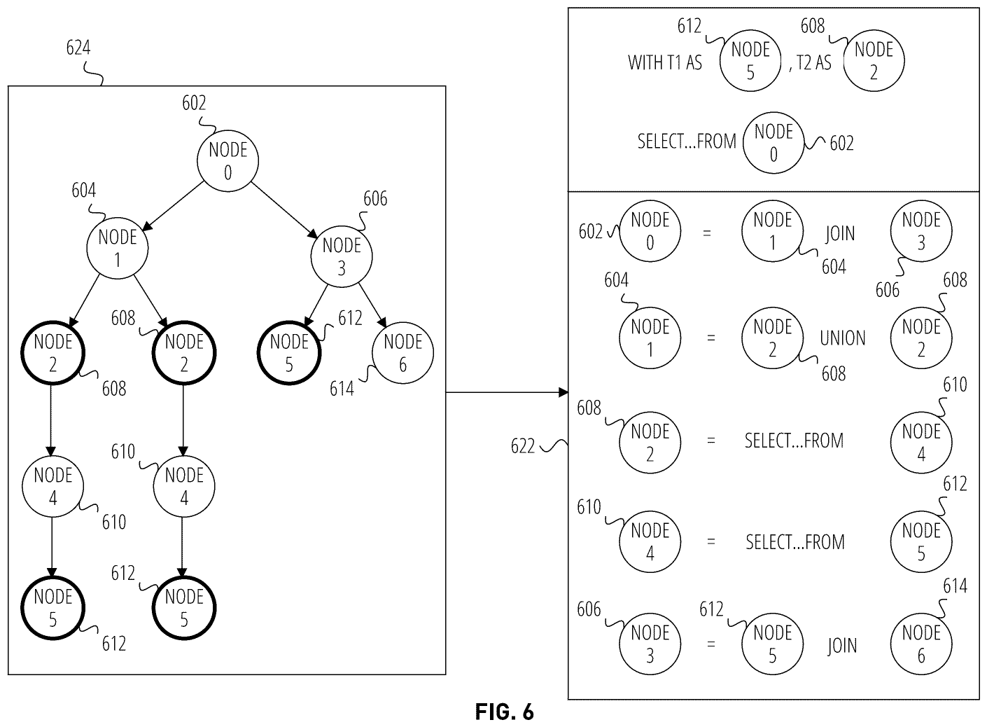

FIG. 6 illustrates a process of converting repeated subqueries in a logical plan tree 624 into optimized subqueries, such as CTEs, according to some examples. The logical plan tree 624 includes a root node or node 0 602. The node 0 602 includes two child nodes node 1 604 and node 3 606. Node 0 602 represents a join of node 1 604 and node 3 606. Node 1 604 represents a union of two subtrees of node 2 608. Each subtree includes node 4 610 and node 5 612. Node 3 606 represents a join between node 5 612 and node 6 614. Duplicated node 2 608 and node 5 612 are identified as roots of duplicate subtrees. While node 4 610 is a duplicate node, node 4 610 won't be replaced with its own CTE because node 4 610 will be replaced during the process of replacing the duplicate subtree having node 2 608 as its root. Node 5 612 is identified as a duplicate subtree to be replaced as it has two parent nodes that are different, namely node 4 610 and node 3 606.

An optimized query 622 illustrates that node 5 612 is replaced with CTE T1 and node 2 608 is replaced with CTE T2. The resulting query structure is represented as:
WITH T1 AS node 5 612, T2 AS node 2 608
SELECT . . . FROM node 0
Node 0 602=Node 1 604 JOIN Node 3 606
Node 1 604=Node 2 608 UNION Node 2 608
Node 2 608=SELECT . . . FROM Node 4 610
Node 4 610=SELECT . . . FROM Node 5 612
Node 3 606=Node 5 612 JOIN Node 6 614

This optimization eliminates the repeated computation of node 2 608 and node 5 612, improving query performance by reducing redundant operations.

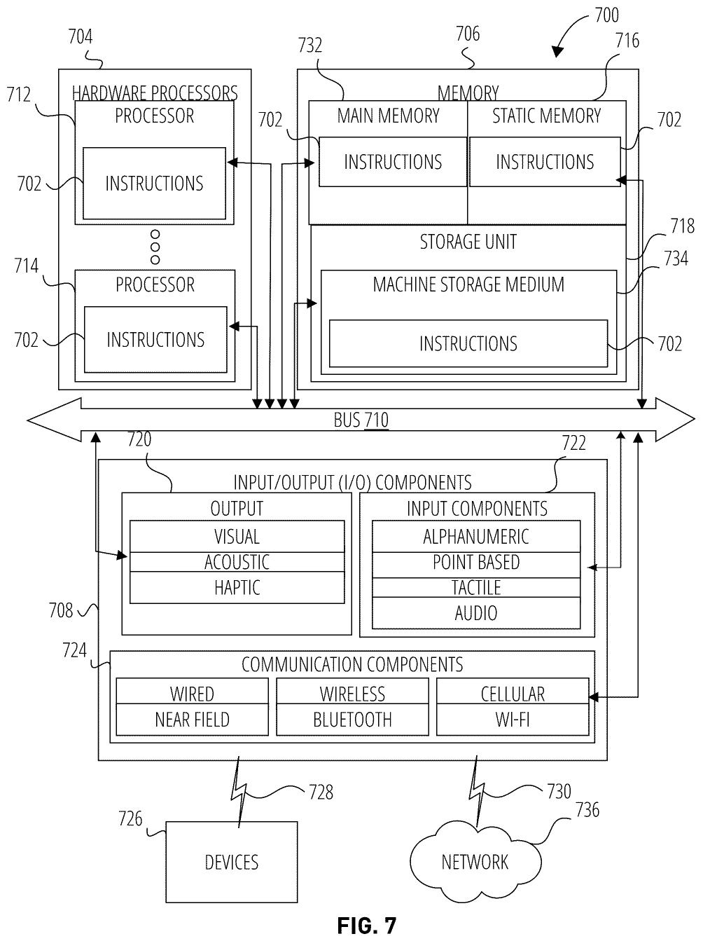

FIG. 7 illustrates a diagrammatic representation of a machine 700 in the form of a computer system within which a set of instructions may be executed for causing the machine 700 to perform any one or more of the methodologies discussed herein, according to examples. Specifically, FIG. 7 shows a diagrammatic representation of the machine 700 in the example form of a computer system, within which instructions 702 (e.g., software, a program, an application, an applet, an application, or other executable code) for causing the machine 700 to perform any one or more of the methodologies discussed herein may be executed. For example, the instructions 702 may cause the machine 700 to execute any one or more operations of any one or more of the methods described herein. In this way, the instructions 702 transform a general, non-programmed machine into a particular machine 700 (e.g., the compute service manager 104, the execution platform 110, and the data storage devices 108-1 to 108-N of data storage system 106) that is specially configured to carry out any one of the described and illustrated functions in the manner described herein.

In alternative examples, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 702, sequentially or otherwise, that specify actions to be taken by the machine 700. Further, while only a single machine 700 is illustrated, the term “machine” shall also be taken to include a collection of machines that individually or jointly execute the instructions 702 to perform any one or more of the methodologies discussed herein.

The machine 700 includes hardware processors 704, memory 706, and I/O components 708 configured to communicate with each other such as via a bus 710. In some examples, the hardware processors 704 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another hardware processor, or any suitable combination thereof) may include, for example, multiple processors as exemplified by processor 712 and a processor 714 that may execute the instructions 702. The term “processor” is intended to include multi-core processors that may comprise two or more independent processors (sometimes referred to as “cores”) that may execute instructions 702 contemporaneously. Although FIG. 7 shows multiple hardware processors 704, the machine 700 may include a single processor with a single core, a single processor with multiple cores (e.g., a multi-core processor), multiple processors with a single core, multiple processors with multiple cores, or any combination thereof.

The memory 706 may include a main memory 732, a static memory 716, and a storage unit 718 including a machine storage medium 734, accessible to the hardware processors 704 such as via the bus 710. The main memory 732, the static memory 716, and the storage unit 718 store the instructions 702 embodying any one or more of the methodologies or functions described herein. The instructions 702 may also reside, completely or partially, within the main memory 732, within the static memory 716, within the storage unit 718, within at least one of the hardware processors 704 (e.g., within the processor's cache memory), or any suitable combination thereof, during execution thereof by the machine 700.

The input/output (I/O) components 708 include components to receive input, provide output, produce output, transmit information, exchange information, capture measurements, and so on. The specific I/O components 708 that are included in a particular machine 700 will depend on the type of machine. For example, portable machines such as mobile phones will likely include a touch input device or other such input mechanisms, while a headless server machine will likely not include such a touch input device. It will be appreciated that the I/O components 708 may include many other components that are not shown in FIG. 7. The I/O components 708 are grouped according to functionality merely for simplifying the following discussion and the grouping is in no way limiting. In various examples, the I/O components 708 may include output components 720 and input components 722. The output components 720 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 722 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 708 may include communication components 724 operable to couple the machine 700 to a network 736 or devices 726 via a coupling 730 and a coupling 728, respectively. For example, the communication components 724 may include a network interface component or another suitable device to interface with the network 736. In further examples, the communication components 724 may include wired communication components, wireless communication components, cellular communication components, and other communication components to provide communication via other modalities. The devices 726 may be another machine or any of a wide variety of peripheral devices (e.g., a peripheral device coupled via a universal serial bus (USB)). For example, as noted above, the machine 700 may correspond to any one of the compute service manager 104, the execution platform 110, and the devices 726 may include the data storage device 226 or any other computing device described herein as being in communication with the data platform 102 or the data storage system 106.

The various memories (e.g., 706, 716, 732, and/or memory of the processor(s) 704 and/or the storage unit 718) may store one or more sets of instructions 702 and data structures (e.g., software) embodying or utilized by any one or more of the methodologies or functions described herein. These instructions 702, when executed by the processor(s) 704, cause various operations to implement the disclosed examples.

Described implementations of the subject matter can include one or more features, alone or in combination as illustrated below by way of example:

Example 1 is a machine-implemented method, comprising: creating a logical plan tree for a Structured Query Language (SQL) query, the logical plan tree comprising a set of nodes; identifying a set of duplicate nodes in the set of nodes of the logical plan tree; identifying a duplicate subtree in the logical plan tree by determining a set of root nodes of the duplicate subtree using parent-child relationships of the set of nodes, the duplicate subtree representing a duplicate subquery of the SQL query; generating an optimized query by replacing a set of instances of the duplicate subquery by a set of instances of the duplicate subtree in the logical plan tree using a set of optimized subqueries; and communicating the optimized query to a data platform for execution of the optimized query.

In Example 2, the subject matter of Example 1 includes, wherein the set of optimized subqueries comprises a first instance of the duplicate subquery including instructions to create a Common Table Expression (CTE) and one or more subsequent references to the CTE.

In Example 3, the subject matter of any of Examples 1-2 includes, wherein the set of optimized subqueries comprises a first instance of the duplicate subquery and one or more subsequent references to a stored result of the first instance of the duplicate subquery.

In Example 4, the subject matter of any of Examples 1-3 includes, wherein the one or more subsequent references comprise references to a materialized result of the first instance of the duplicate subquery.

In Example 5, the subject matter of any of Examples 1-4 includes, wherein the one or more subsequent references comprise a query identification referencing the stored result of the first instance of the duplicate subquery.

In Example 6, the subject matter of any of Examples 1-5 includes, wherein determining the set of root nodes of the set of instances of the duplicate subtree comprises: for each duplicate node of the set of duplicate nodes, performing operations comprising: determining at least one parent node of the each duplicate node is not in the set of duplicate nodes; and in response to determining the at least one parent node is not in the set of duplicate nodes, adding the each duplicate node to the set of root nodes.

In Example 7, the subject matter of any of Examples 1-6 includes, wherein determining the set of root nodes of the set of instances of the duplicate subtree comprises: for each duplicate node of the set of duplicate nodes, performing operations comprising: determining the each duplicate node has two or more different parent nodes; and in response to determining the each duplicate node has two or more different parent nodes, adding the each duplicate node to the set of root nodes.

In Example 8, the subject matter of any of Examples 1-7 includes, wherein replacing a set of instances of the duplicate subquery comprises: searching a query string of each duplicate node of the set of duplicate nodes iteratively in post order to locate an instance of the duplicate subtree in the SQL query; and replacing an instance of a subquery represented by the instance of the duplicate subtree with an optimized subquery of the set of optimized subqueries.

In Example 9, the subject matter of any of Examples 1-8 includes, wherein generating the optimized query comprises: generating an additional query including unique placeholder for each child node of the logical plan tree of the SQL query; and replacing the placeholder with an optimized subquery of the set of optimized subqueries during an evaluation of the SQL query.

In Example 10, the subject matter of any of Examples 1-9 includes, wherein replacing the set of instances of the duplicate subquery comprises: identifying an instance of the duplicate subquery represented by the duplicate subtree when applying a binary operation during DataFrame creation; and replacing the instance of the duplicate subtree with an optimized subquery of the set of optimized subqueries.

In Example 11, the subject matter of any of Examples 1-10 includes, wherein replacing the set of instances of the duplicate subquery further comprises: determining a size of the set of root nodes of the duplicate subtree; in response to determining the size of the set of root node does not exceed a threshold size value, determining to replace instances of a subquery represented by the duplicate subtree with the set of optimized queries.

In Example 12, the subject matter of any of Examples 1-11 includes, wherein replacing the set of instances of the duplicate subquery further comprises: determining a depth of nested subtrees in the duplicate subtree; in response to determining the depth of nested of subtrees does not exceed a threshold depth value, determining to replace instances of a subquery represented by the duplicate subtree with the set of optimized queries.

Example 13 is at least one machine-readable medium including instructions that, when executed by processing circuitry, cause the processing circuitry to perform operations to implement any one or more of Examples 1-12.

Example 14 is an apparatus comprising means to implement any one or more of Examples 1-12.

Example 15 is a system to implement any one or more of Examples 1-12.

Example 16 is a method to implement any one or more of Examples 1-12.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various examples, one or more portions of the network 736 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 736 or a portion of the network 736 may include a wireless or cellular network, and the coupling 730 may be a Code Division Multiple Access (CDMA) connection, a Global System for Mobile communications (GSM) connection, or another type of cellular or wireless coupling. In this example, the coupling 730 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 702 may be transmitted or received over the network 736 using a transmission medium via a network interface device (e.g., a network interface component included in the communication components 724) and utilizing any one of a number of well-known transfer protocols (e.g., hypertext transfer protocol (HTTP)). Similarly, the instructions 702 may be transmitted or received using a transmission medium via the coupling 728 (e.g., a peer-to-peer coupling) to the devices 726. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 702 for execution by the machine 700, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methodologies disclosed herein may be performed by one or more processors. The performance of certain of the operations may be distributed among the one or more processors, not only residing within a single machine, but also deployed across a number of machines. In some examples, the processor or processors may be located in a single location (e.g., within a home environment, an office environment, or a server farm), while in other examples the processors may be distributed across a number of locations.

Described implementations of the subject matter can include one or more features, alone or in combination as illustrated below by way of example.

Although the examples of the present disclosure have been described with reference to specific examples, it will be evident that various modifications and changes may be made to these examples without departing from the broader scope of the inventive subject matter. Accordingly, the specification and drawings are to be regarded in an illustrative rather than a restrictive sense. The accompanying drawings that form a part hereof show, by way of illustration, and not of limitation, specific examples in which the subject matter may be practiced. The examples illustrated are described in sufficient detail to enable those skilled in the art to practice the teachings disclosed herein. Other examples may be used and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Such examples of the inventive subject matter may be referred to herein, individually and/or collectively, by the term “example” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art, upon reviewing the above description.

What is claimed is:

1. A machine-implemented method, comprising:
creating a logical plan tree for a Structured Query Language (SQL) query, the logical plan tree comprising a set of nodes;
identifying a set of duplicate nodes in the set of nodes of the logical plan tree;
identifying a duplicate subtree in the logical plan tree by determining a set of root nodes of the duplicate subtree using parent-child relationships of the set of nodes, the duplicate subtree representing a duplicate subquery of the SQL query;
generating an optimized query by replacing a set of instances of the duplicate subquery by a set of instances of the duplicate subtree in the logical plan tree using a set of optimized subqueries; and
communicating the optimized query to a data platform for execution of the optimized query.

2. The machine-implemented method of claim 1, wherein the set of optimized subqueries comprises a first instance of the duplicate subquery including instructions to create a Common Table Expression (CTE) and one or more subsequent references to the CTE.

3. The machine-implemented method of claim 1, wherein the set of optimized subqueries comprises a first instance of the duplicate subquery and one or more subsequent references to a stored result of the first instance of the duplicate subquery.

4. The machine-implemented method of claim 3, wherein the one or more subsequent references comprise references to a materialized result of the first instance of the duplicate subquery.

5. The machine-implemented method of claim 3, wherein the one or more subsequent references comprise a query identification referencing the stored result of the first instance of the duplicate subquery.

6. The machine-implemented method of claim 1, wherein determining the set of root nodes of the set of instances of the duplicate subtree comprises:
for each duplicate node of the set of duplicate nodes, performing operations comprising:
determining at least one parent node of the each duplicate node is not in the set of duplicate nodes; and
in response to determining the at least one parent node is not in the set of duplicate nodes, adding the each duplicate node to the set of root nodes.

7. The machine-implemented method of claim 1, wherein determining the set of root nodes of the set of instances of the duplicate subtree comprises:
for each duplicate node of the set of duplicate nodes, performing operations comprising:
determining the each duplicate node has two or more different parent nodes; and
in response to determining the each duplicate node has two or more different parent nodes, adding the each duplicate node to the set of root nodes.

8. The machine-implemented method of claim 1, wherein replacing a set of instances of the duplicate subquery comprises:
searching a query string of each duplicate node of the set of duplicate nodes iteratively in post order to locate an instance of the duplicate subtree in the SQL query; and
replacing an instance of a subquery represented by the instance of the duplicate subtree with an optimized subquery of the set of optimized subqueries.

9. The machine-implemented method of claim 1, wherein generating the optimized query comprises:
generating an additional query including unique placeholder for each child node of the logical plan tree of the SQL query; and
replacing the placeholder with an optimized subquery of the set of optimized subqueries during an evaluation of the SQL query.

10. The machine-implemented method of claim 1, wherein replacing the set of instances of the duplicate subquery comprises:
identifying an instance of the duplicate subquery represented by the duplicate subtree when applying a binary operation during DataFrame creation; and
replacing the instance of the duplicate subtree with an optimized subquery of the set of optimized subqueries.

11. A system comprising:
at least one processor; and
at least one memory storing instructions that, when executed by the at least one processor, cause the system to perform operations comprising:
creating a logical plan tree for a Structured Query Language (SQL) query, the logical plan tree comprising a set of nodes;
identifying a set of duplicate nodes in the set of nodes of the logical plan tree;
identifying a duplicate subtree in the logical plan tree by determining a set of root nodes of the duplicate subtree using parent-child relationships of the set of nodes, the duplicate subtree representing a duplicate subquery of the SQL query;
generating an optimized query by replacing a set of instances of the duplicate subquery by a set of instances of the duplicate subtree in the logical plan tree using a set of optimized subqueries; and
communicating the optimized query to a data platform for execution of the optimized query.

12. The system of claim 11, wherein the set of optimized subqueries comprises a first instance of the duplicate subquery including instructions to create a Common Table Expression (CTE) and one or more subsequent references to the CTE.

13. The system of claim 11, wherein the set of optimized subqueries comprises a first instance of the duplicate subquery and one or more subsequent references to a stored result of the first instance of the duplicate subquery.

14. The system of claim 13, wherein the one or more subsequent references comprise references to a materialized result of the first instance of the duplicate subquery.

15. The system of claim 13, wherein the one or more subsequent references comprise a query identification referencing the stored result of the first instance of the duplicate subquery.

16. The system of claim 11, wherein determining the set of root nodes of the set of instances of the duplicate subtree comprises:
for each duplicate node of the set of duplicate nodes, performing operations comprising:
determining at least one parent node of the each duplicate node is not in the set of duplicate nodes; and
in response to determining the at least one parent node is not in the set of duplicate nodes, adding the each duplicate node to the set of root nodes.

17. The system of claim 11, wherein determining the set of root nodes of the set of instances of the duplicate subtree comprises:
for each duplicate node of the set of duplicate nodes, performing operations comprising:
determining the each duplicate node has two or more different parent nodes; and
in response to determining the each duplicate node has two or more different parent nodes, adding the each duplicate node to the set of root nodes.

18. The system of claim 11, wherein replacing a set of instances of the duplicate subquery comprises:
searching a query string of each duplicate node of the set of duplicate nodes iteratively in post order to locate an instance of the duplicate subtree in the SQL query; and
replacing an instance of a subquery represented by the instance of the duplicate subtree with an optimized subquery of the set of optimized subqueries.

19. The system of claim 11, wherein generating the optimized query comprises:
generating an additional query including unique placeholder for each child node of the logical plan tree of the SQL query; and
replacing the placeholder with an optimized subquery of the set of optimized subqueries during an evaluation of the SQL query.

20. The system of claim 11, wherein replacing the set of instances of the duplicate subquery comprises:
identifying an instance of the duplicate subquery represented by the duplicate subtree when applying a binary operation during DataFrame creation; and
replacing the instance of the duplicate subtree with an optimized subquery of the set of optimized subqueries.

21. A machine-storage medium storing instructions that, when executed by one or more processors of a system, cause the system to perform operations comprising:
creating a logical plan tree for a Structured Query Language (SQL) query, the logical plan tree comprising a set of nodes;
identifying a set of duplicate nodes in the set of nodes of the logical plan tree;
identifying a duplicate subtree in the logical plan tree by determining a set of root nodes of the duplicate subtree using parent-child relationships of the set of nodes, the duplicate subtree representing a duplicate subquery of the SQL query;
generating an optimized query by replacing a set of instances of the duplicate subquery by a set of instances of the duplicate subtree in the logical plan tree using a set of optimized subqueries; and
communicating the optimized query to a data platform for execution of the optimized query.

22. The machine-storage medium of claim 21, wherein the set of optimized subqueries comprises a first instance of the duplicate subquery including instructions to create a Common Table Expression (CTE) and one or more subsequent references to the CTE.

23. The machine-storage medium of claim 21, wherein the set of optimized subqueries comprises a first instance of the duplicate subquery and one or more subsequent references to a stored result of the first instance of the duplicate subquery.

24. The machine-storage medium of claim 23, wherein the one or more subsequent references comprise references to a materialized result of the first instance of the duplicate subquery.

25. The machine-storage medium of claim 23, wherein the one or more subsequent references comprise a query identification referencing the stored result of the first instance of the duplicate subquery.

26. The machine-storage medium of claim 21, wherein determining the set of root nodes of the set of instances of the duplicate subtree comprises:
for each duplicate node of the set of duplicate nodes, performing operations comprising:
determining at least one parent node of the each duplicate node is not in the set of duplicate nodes; and
in response to determining the at least one parent node is not in the set of duplicate nodes, adding the each duplicate node to the set of root nodes.

27. The machine-storage medium of claim 21, wherein determining the set of root nodes of the set of instances of the duplicate subtree comprises:
for each duplicate node of the set of duplicate nodes, performing operations comprising:
determining the each duplicate node has two or more different parent nodes; and
in response to determining the each duplicate node has two or more different parent nodes, adding the each duplicate node to the set of root nodes.

28. The machine-storage medium of claim 21, wherein replacing a set of instances of the duplicate subquery comprises:
searching a query string of each duplicate node of the set of duplicate nodes iteratively in post order to locate an instance of the duplicate subtree in the SQL query; and
replacing an instance of a subquery represented by the instance of the duplicate subtree with an optimized subquery of the set of optimized subqueries.

29. The machine-storage medium of claim 21, wherein generating the optimized query comprises:
generating an additional query including unique placeholder for each child node of the logical plan tree of the SQL query; and
replacing the placeholder with an optimized subquery of the set of optimized subqueries during an evaluation of the SQL query.

30. The machine-storage medium of claim 21, wherein replacing the set of instances of the duplicate subquery comprises:
identifying an instance of the duplicate subquery represented by the duplicate subtree when applying a binary operation during DataFrame creation; and
replacing the instance of the duplicate subtree with an optimized subquery of the set of optimized subqueries.
